(19) United States
(12) Patent Application Publication
(10) Pub. No.: US 2012/0216797 A1
(43) Pub. Date: Aug. 30, 2012

(54) BAFFLE FOR A FIREPLACE

(75) Inventors: Joseph A. Benedetti, Nashville, TN (US); Michael L. Bennett, White House, TN (US); Kenneth D. Johns, Chapel Hill, TN (US)

(73) Assignee: Lennox Hearth Products LLC., Nashville, TN (US)

(21) Appl. No.: 13/154,005

(22) Filed: Jun. 6, 2011

Related U.S. Application Data
(60) Provisional application No. 61/446,939, filed on Feb. 25, 2011.

(51) Int. Cl. F24C 3/00; B23P 17/00

(52) U.S. Cl. 126/552; 29/592

(57) ABSTRACT

A heat deflection member having a first bend along a central axis of the heat deflection member that forms first and second opposing panels, and opposing first and second parallel edges of the heat deflection member having second and third bends formed parallel the central axis that form opposing first and second coupling flanges along at least a portion of a length of the opposing edges. A method of manufacturing a fireplace baffle and a pre-fabricated fireplace are also provided.

### CROSS-REFERENCE TO RELATED APPLICATION

This application claims the benefit of U.S. Provisional Application Ser. No. 61446939, filed by Joseph A. Benedetti on Feb. 25, 2011, entitled “IMPROVED LINEAR FIREPLACE WITH BURNER,” commonly assigned with this application and incorporated herein by reference.

### TECHNICAL FIELD

This application is directed, in general, to a prefabricated fireplace and, more specifically, to a flue baffle for a gas prefabricated fireplace.

### BACKGROUND

Some modern pre-fabricated fireplaces may be made so as to have two opposing hearths wherein each may be in separate interior rooms, or one may be in an interior room and the other directed to a patio or outdoor living area. With this arrangement, the fire is centrally located within the firebox and serves both hearths. These may be referred to as “See Thru” fireplaces. Often these fireplaces may have no damper in a centrally-located, common flue as well as having two screens/glass fronts, each one facing one of the hearths. Under normal circumstances, the absence of a damper would allow much radiant and convective heat to be lost up the central flue along with the fire by-products. To minimize the loss of radiant and convective heat up the flue, as well as to hide what might be considered an esthetically-undesirable, open flue, conventional baffles have been provided. These conventional baffles are not adequate to disperse or redirect, in a controlled fashion, the heat produced so as to accommodate the input BTU rate required for the fireplace assembly. Reflecting radiant heat back toward the floor of the firebox generally increases the heat that the firebox floor must absorb, and consequently limits the BTUs of the fireplace assembly.

### SUMMARY

One aspect provides a heat deflection member having a first bend along a central axis of the heat deflection member that forms first and second opposing panels, and opposing first and second parallel edges of the heat deflection member having second and third bends formed parallel the central axis that form opposing first and second coupling flanges along at least a portion of a length of the opposing edges.

Another aspect provides a method of manufacturing a fireplace baffle comprising forming a heat deflection member having a first bend along a central axis of the heat deflection member that forms first and second opposing panels, and forming second and third bends parallel the central axis that form opposing first and second coupling flanges along at least a portion of a length of opposing first and second parallel edges of the heat deflection member. A prefabricated fireplace assembly is also provided.

### BRIEF DESCRIPTION

Reference is now made to the following descriptions taken in conjunction with the accompanying drawings, in which:

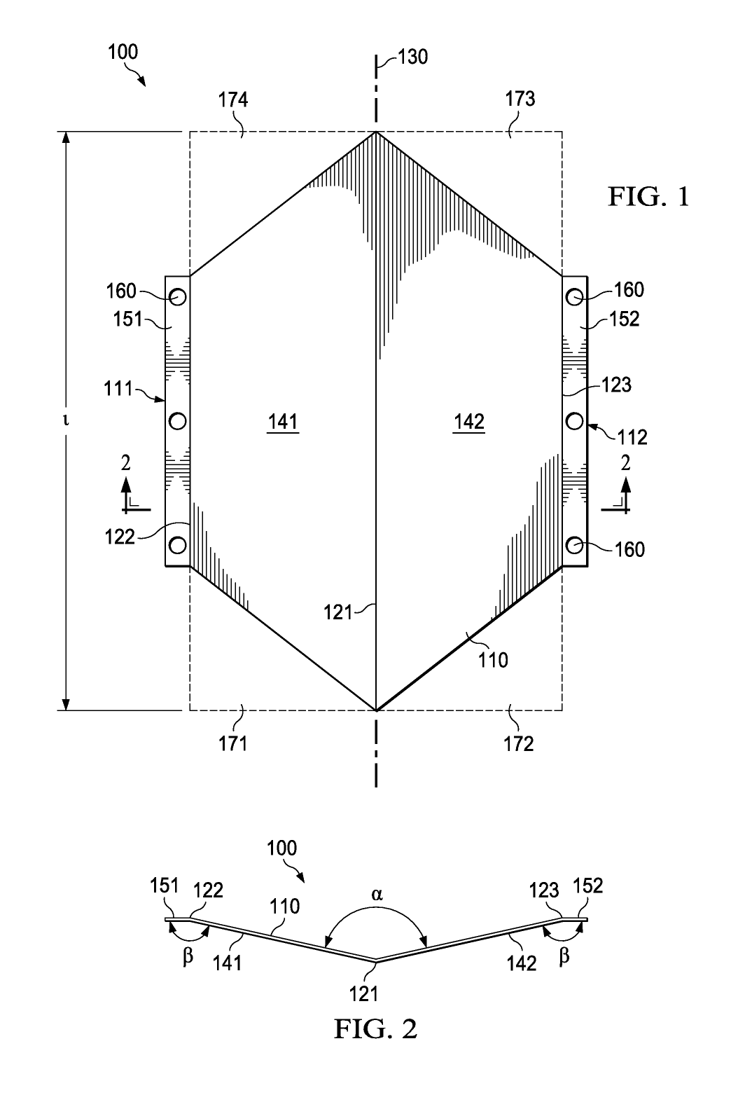

FIG. 1 is a plan view of one embodiment of a fireplace baffle 100 constructed in accordance with the present disclosure;

FIG. 2 is a sectional view of one embodiment of a fireplace baffle 100 of FIG. 1 along plane 2-2;

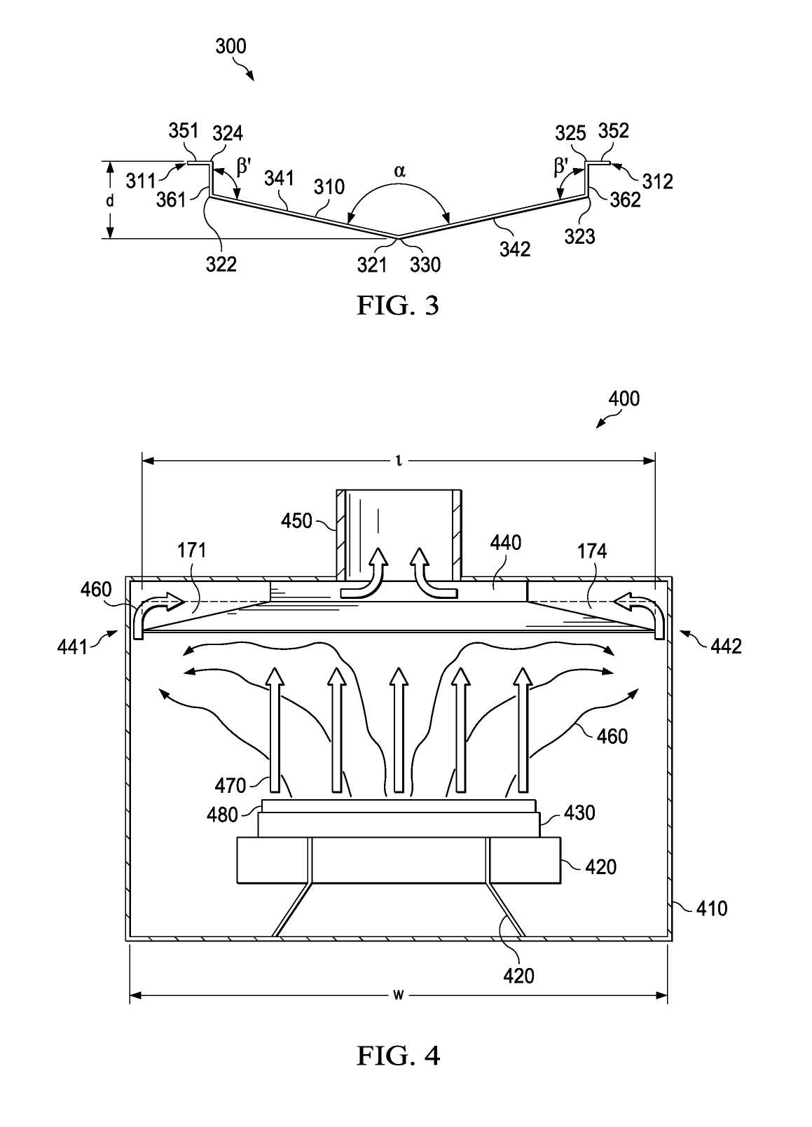

FIG. 3 is a sectional view of an alternative and preferred embodiment of a fireplace baffle 300 along plane 2-2 of FIG. 1;

FIG. 4 is a vertical sectional view of a prefabricated fireplace 400 along the centerline 130 of FIG. 1;

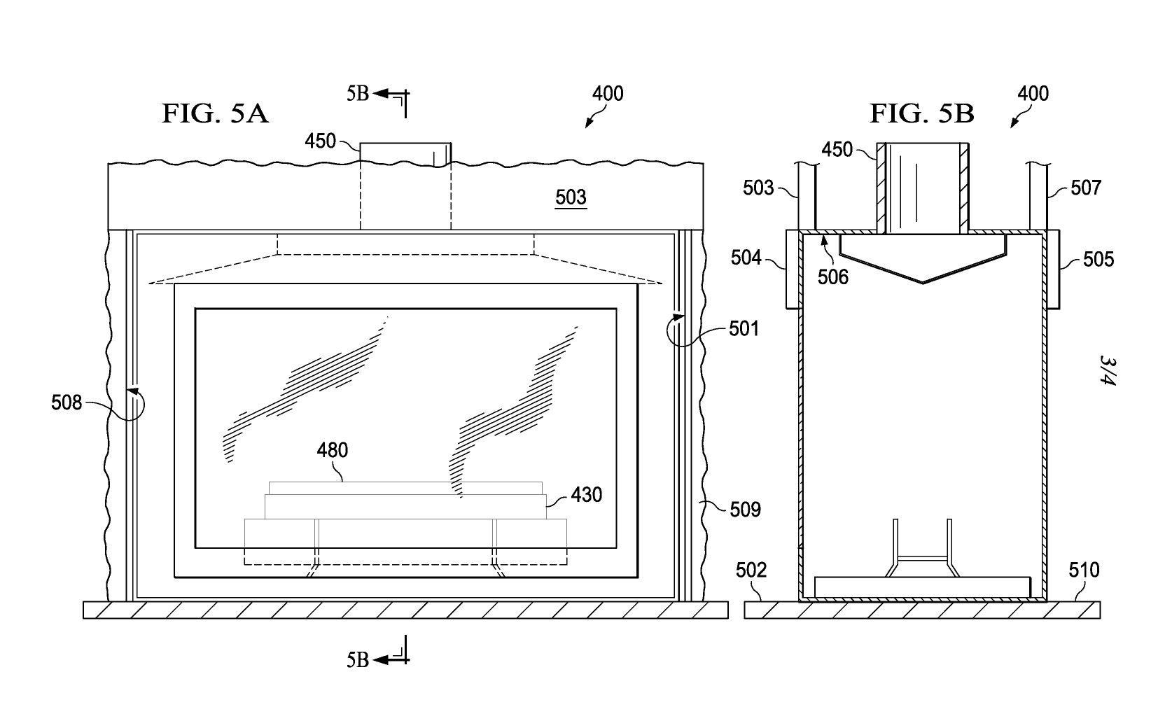

FIG. 5A is a front elevation view of a prefabricated fireplace constructed in accordance with the present disclosure;

FIG. 5B is a vertical sectional view of a prefabricated fireplace constructed in accordance with the present disclosure; and

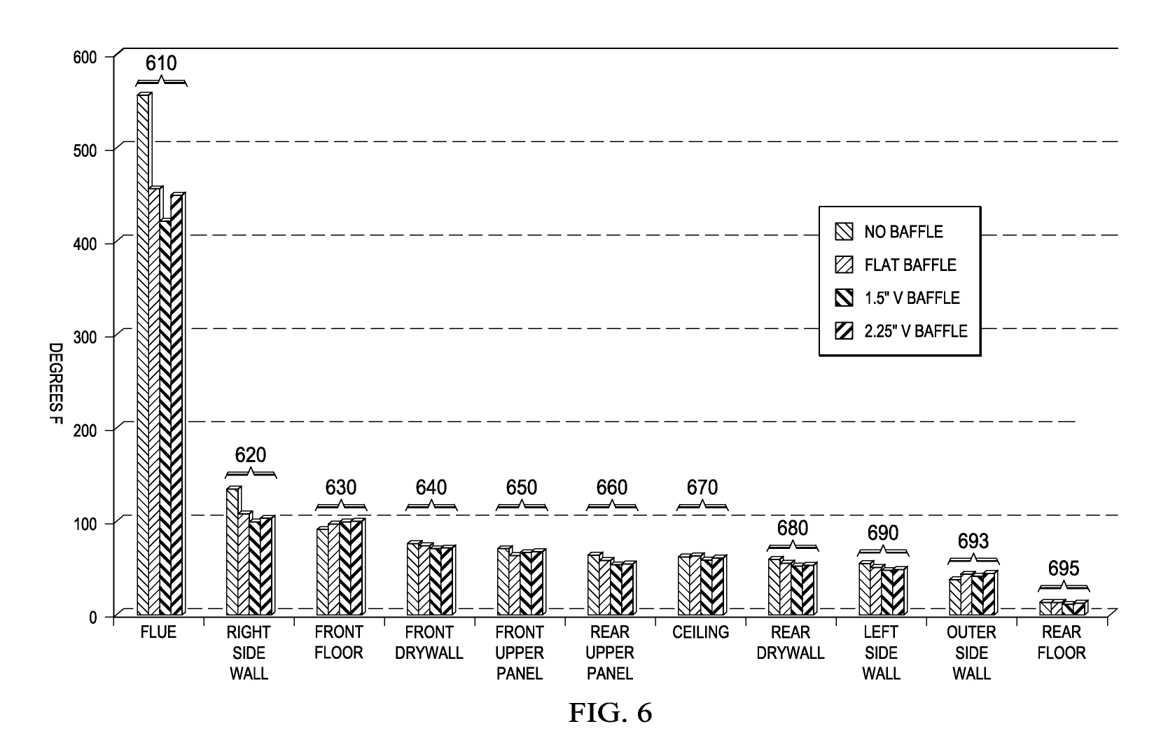

FIG. 6 is a chart of average temperatures of cabinet, flue and selected surroundings collected with thermocouples at locations within and without one representative prefabricated fireplace with each of the four baffle configurations.

### DETAILED DESCRIPTION

Referring initially to FIG. 1, illustrated is a plan view of one embodiment of a fireplace baffle 100 constructed in accordance with the present disclosure. In the illustrated embodiment, the fireplace baffle 100 comprises a sheet-metal, heat deflection member 110 having first and second parallel edges 111, 112 and a first bend 121 along a centerline 130 thereof, and second and third bends 122, 123, parallel the first and second parallel edges 111, 112, thereby forming first and second opposing panels 141, 142, and first and second parallel mounting flanges 151, 152. As used herein, the term “bend” includes not only those instances where sheet metal is mechanically bent, but it also includes those instances where the bend is formed by welding, brazing, or otherwise attaching individual pieces of metal together. The term “bend” also includes forming the bend in a moldable material, such as a ceramic or similar material, that can be used to produce the heat deflection member 110. In certain embodiments, the fireplace baffle 100 may also comprise a plurality of mounting apertures 160 distributed along the first and second mounting flanges 151, 152. In a preferred embodiment, the heat deflection member 110 may comprise sheet steel of a thickness from about 30 gauge to about 12 gauge. Of course, other metals such as: stainless steel, aluminum, etc., may also be used. As previously stated, the heat deflection member 110 may also comprise ceramic or other similar material. The first and second opposing panels 141, 142 may be trapezoidal in shape with the first and second mounting flanges 151, 152 attached to the short parallel sides of the first and second opposing panels 141, 142, respectively. To be described below, cutoffs 171-174 will provide voids through which combustion products will exit a firebox. The first bend 121 has a length 1 that is slightly shorter than an interior wall-to-wall measurement of a firebox (shown below). The first and second mounting flanges 151, 152 need not be continuous along the short parallel sides of the first and second opposing panels 141, 142, respectively, but may be intermittent yet of sufficient length to support the fireplace baffle 100. The plurality of mounting apertures 160, when present, may be used to fasten the fireplace baffle 100 to the ceiling of a gas prefabricated fireplace by any suitable method, e.g., bolts, rivets, etc. Alternatively, a baffle of ceramic or other similar material may be attached without fasteners to the firebox ceiling by sliding into appropriately placed channels attached to the ceiling.

Referring now to FIG. 2, illustrated is a sectional view of one embodiment of a fireplace baffle 100 of FIG. 1 along plane 2-2. In forming the first, second and third bends 121-123, the sheet metal member 110 may literally be bent in a bending brake or metal-forming press, or the bends may be formed by welding, brazing, etc., individual pieces of sheet metal, as appropriate. The first bend 121 may form an obtuse interior angle α ranging from about 91° to about 179°. In one embodiment, the interior angle α is about 160°. The first and second mounting flanges 151, 152 may extend from the first and second opposing panels 141, 142 at an interior angle β that may vary from about 135° to about 179°. In one embodiment compatible with an interior angle α of 160°, the interior angle β is about 170°.

Referring now to FIG. 3, illustrated is a sectional view of an alternative embodiment of a fireplace baffle 300 along plane 2-2 of FIG. 1. In this embodiment, the fireplace baffle 300 comprises a sheet-metal, heat deflection member 310 having first and second parallel edges 311, 312 and a first bend 321 along a centerline 330 thereof. The sheet-metal, heat deflection member 310 further comprises second through fifth bends 322-325, respectively, parallel the first and second parallel edges 311, 312, and forming: first and second opposing panels 341, 342, first and second panel extensions 361, 362, and first and second parallel mounting flanges 351, 352. As in the embodiment of FIG. 2, forming of the first through fifth bends 321-325 may be achieved with the sheet metal member 310 literally bent in a bending brake or a metal-forming press, or the bends 321-325 may be formed by welding, brazing, etc., individual pieces of sheet metal, as appropriate to the material used. The first bend 321 forms an obtuse interior angle α whose value may range from about 91° and to about 179°. In one preferred embodiment, the interior angle α may be about 160°. The first and second panel extensions 361, 362, respectively, extend from the fourth and fifth bends 324, 325, respectively. The fourth and fifth bends 324, 325 form interior angles β′. The first and second mounting flanges 351, 352 extend from the first and second opposing panels 341, 342 at interior angles β′, that may vary from about 134.5° to about 90.5°, respectively. In this embodiment compatible with an interior angle α of 160°, the interior angles β′ are about 100°. The fireplace baffle 300 has a height h measured from the bottom of the “V” to the height of the first and second mounting flanges 351, 352 as shown.

Referring now to FIG. 4, illustrated is a vertical sectional view of a prefabricated gas fireplace 400 along the centerline 130 of FIG. 1 and constructed in accordance with the present disclosure. The fireplace 400 comprises a firebox 410, a grate 420, a gas burner 430, a fireplace baffle 440, and a flue 450. Note that the fireplace baffle 440 is almost equal in length l to the inside width w of the firebox 410. It should be noted that radiant heat travels in substantially straight lines, while convection heat travels as the gases move about the firebox 410 and up the flue 450. As the fire burns, thermal currents (convection heat) cause combustion products 460 to rise in the firebox 410. Upon reaching the fireplace baffle 440, the combustion products 460 are prevented from immediately entering the flue 450, but are rather redirected toward first and second ends 441, 442 of the fireplace baffle 440. Without some form of baffle below the flue, much radiant and convective heat would be lost unimpeded up the flue, thus creating higher flue temperatures as will be discussed with reference to FIG. 6 below. Upon reaching the first and second ends 441, 442, the combustion products 460 flow around the cutoffs 171-174 (See also FIG. 1) and back toward a center of the fireplace baffle 440, then upward and out the flue 450. While combustion products are thus effectively exhausted, radiant heat 470 created by the gas burner 430 is emitted in straight lines in all directions from the flame 480. Because of the angled nature of the first and second opposing panels 141, 142, or 341, 342, respectively, the radiant heat 470 is redirected upon impinging the first and second opposing panels 141, 142 or 341, 342, toward the glass front of the fireplace 400 or desired areas within the firebox 410, and ultimately toward the space proximate the outside face of the fireplace 400, thus making the fireplace 400 more efficient in directing heat where it is most desired. The degree to which radiant heat is redirected can be controlled by the choice of the angle α (See FIG. 3) of the fireplace baffle 440. Variation in this angle can be controlled by adjusting the depth d of the fireplace baffle 440 (See FIG. 3). It should be noted that adjusting the depth d of the fireplace baffle 440 will also affect the esthetics of the fireplace 400 as a greater depth d will be more visible through the glass doors than a shallow depth d.

Referring now to FIG. 5A and 5B, illustrated are front elevation and vertical sectional views, respectively, of a representative prefabricated fireplace constructed in accordance with the present disclosure. For a three-hour test, the test fireplace 400 was installed in an enclosure similar to how the fireplace would be installed in a home. In this instance, the fireplace 400 was installed in an enclosure that included drywall above the fireplace doors, proximate the left and right firebox walls, and extending forward from the right firebox wall to simulate installing the fireplace in a corner of a room. Multiple thermocouples were distributed over each area or panel of interest. The panels or areas were: the flue 450, right side wall 501, front floor 502, front drywall 503, front upper panel 504, rear upper panel 505, firebox ceiling 506, rear drywall 507, left side wall 508, outer side wall 509, and rear floor 510. The right side wall 501, front drywall 503, rear drywall 507, left side wall 508, and outer side wall 509 are parts of the enclosure surrounding the test fireplace 400 replicating how it might be installed in a room. The outer side wall 509 is an extension of the test enclosure and simulates a wall adjacent to the fireplace 400. The front floor 502 and rear floor 510 are the areas of the facility floor in front of and behind the test fireplace 400, respectively. The front upper panel 504, rear upper panel 505 and firebox ceiling 506 are parts of the fireplace 400. Four different baffle configurations of the fireplace were tested. The four configurations of the fireplace are: (a) no baffle with open flue, (b) flat (conventional) baffle, (c) 1.5″ baffle and (d) 2.25″ baffle. The definition of 1.5″ and 2.25″ baffle refers to the depth d of the baffle with the configuration as shown in FIG. 3.

Referring now to FIG. 6 with continuing reference to FIGS. 5A and 5B, illustrated is a chart of average temperatures of the cabinet, flue and surroundings collected with thermocouples at the above listed locations within and without one representative prefabricated fireplace with each of the four baffle configurations. Test results reflect average temperatures measured with a plurality of thermocouples distributed over a given panel or area as noted above for each of the four different configurations of the fireplace 400. The temperatures were recorded and averaged after three hours of continuous fireplace operation.

Commencing on the left side of the chart, it can be clearly seen from the first column group 610 that the average flue temperature drops for configurations b, c and d above (relative to the no-baffle state, configuration a), due to the baffling holding heat in the firebox area and forcing more radiant heat toward the glass front and the surrounding room. The “V-baffling” (configurations c and d) demonstrate that more radiant heat is directed outwardly toward the glass front and the front floor 502, i.e., the third column group 630. The first column group 610 further demonstrates that the deeper V-baffle (configuration d) allowed more heat to escape into the flue 450 (increased flue temp vs. configuration c); however, overall, the flue temperature was still reduced, i.e., about at least 130° F., and comparable to the conventional baffle (configuration b). Nonetheless, an increased temperature in the front floor area, the third column group 630, was demonstrated; thereby indicating better heat reflection toward the desired area, i.e., the glass front and proximate area. The third column group 630 shows average temperatures recorded at the front floor 502 and indicate an increase in the recorded temperatures for all baffle configurations, b through d, relative to the un-baffled configuration a, from increased heat reflected downwardly and outwardly through the desired area, i.e., the glass front.

The fourth column group 640 shows a slight decrease in the average temperature of the front drywall 503 above the fireplace 400 front as might be expected from reflected radiant heat being directed more toward the floor than toward the upper front of the fireplace 400. Yet, the results show a slight decrease in average temperature at the front drywall of the “V” baffled configurations c and d relative to the conventional flat baffle.

The fifth column group 650 shows a slight increase in average temperature at the front upper panel 504, relative to the conventional flat baffle, likely indicative of increased convective heat caused by the extra radiant heat exiting from the glass front as well as convective currents increased by the increased temperatures of the front floor 502 as shown in the third column group 630.

The second column group 620 (right side wall 501) and the ninth column group 690 (left side wall 508) are more indicative of, and relative to, a reduction in overall enclosure temperatures as they are not as exposed to radiant heat as the other surfaces, and more heat energy is being directed toward and through the glass front than the no-baffle configuration a.

The sixth column group 660 (rear upper panel 505) and the eleventh column group 695 (rear floor 510) do not show much variation from the conventional baffle, configuration b, as the rear glass in this test configuration was both double pane and tinted.

The seventh column group 670 (firebox ceiling 506) shows relatively constant ceiling temperature in all configurations, while the eighth column group 680 (rear drywall 507) shows decreases in average temperatures above the rear glass doors as might be expected because of the double pane and tinted glass of the rear doors.

The tenth column group 693 (outer side wall 509) shows an increase in temperatures on the wall adjacent to the right side of the fireplace 400. This would be indicative of the increased heat emanating from the glass doors of the fireplace 400 thereby heating the proximate surfaces and the surrounding air.

Thus, a new baffle configuration for gas prefabricated fireplaces has been described that dramatically reduces flue temperatures while reflecting more radiant heat toward the desired surface, i.e., the glass front and fireplace surroundings without significant increase in overall firebox temperatures as compared to conventional baffles. A reduction of flue temperature of about at least 130° F. from the no-baffle configuration and yet a reduction of between about 8° F. to about 35° F. from the conventional baffle was seen while other areas, e.g., the front floor increased 2° F. to 3° F. over the conventional baffle yet as much as 5° F. over the no-baffle configuration, indicating improved direction of radiant heat toward the front glass over conventional designs. As such, the fireplace implementing the baffle as covered by the embodiments herein allow a higher BTU per hour or higher temperature operation of the fireplace, thereby providing more heat to a room. While the above discussion has been directed toward a baffle for a gas fireplace, other applications such as stoves, inserts, etc., may also benefit from the described apparatus. It should be noted that the data displayed is for the fireplace configuration as described and exact results using other “V” baffle configurations may vary.

For the purposes of this discussion, use of the terms “providing” and “forming,” etc., includes: manufacture, subcontracting, purchase, etc. Those skilled in the art to which this application relates will appreciate that other and further additions, deletions, substitutions and modifications may be made to the described embodiments.

What is claimed is:

1. A baffle for a fireplace, comprising:
a heat deflection member having a first bend along a central axis of said heat deflection member that forms first and second opposing panels; and
opposing first and second parallel edges of said heat deflection member having second and third bends formed parallel said central axis that form opposing first and second coupling flanges along at least a portion of a length of said opposing edges.

2. The baffle as recited in claim 1 wherein said first bend is parallel said opposing first and second parallel edges.

3. The baffle as recited in claim 1 wherein said first and second opposing panels are trapezoidal.

4. The baffle as recited in claim 1 wherein said baffle has fourth and fifth bends formed parallel said central axis that form opposing first and second panel extensions extending from said first and second coupling flanges to said first and second opposing panels, respectively.

5. The baffle as recited in claim 1 wherein said first bend comprises an obtuse angle.

6. The baffle as recited in claim 5 wherein said obtuse angle ranges from about 91° to about 179°.

7. The baffle as recited in claim 5 wherein said obtuse angle is about 160°.

8. A method of manufacturing a fireplace baffle comprising:
forming a heat deflection member having a first bend along a central axis of said heat deflection member that forms first and second opposing panels; and
forming second and third bends parallel said central axis that form opposing first and second coupling flanges along at least a portion of a length of opposing first and second parallel edges of said heat deflection member.

9. The method as recited in claim 8 wherein forming a heat deflection member includes forming wherein said first bend is parallel said opposing first and second parallel edges.

10. The method as recited in claim 8 wherein forming first and second panels includes forming first and second trapezoidal panels.

11. The method as recited in claim 8 wherein forming said heat deflection member includes forming a heat deflection member having fourth and fifth bends parallel said central axis that form opposing first and second panel extensions extending from said first and second coupling flanges to said first and second opposing panels, respectively.

12. The method as recited in claim 8 wherein forming said heat deflection member includes forming a heat deflection member wherein said bend comprises an obtuse angle.

13. The method as recited in claim 12 wherein forming said heat deflection member includes forming a heat deflection member wherein said obtuse angle ranges from about 91° to about 179°.

14. The method as recited in claim 12 wherein forming said heat deflection member includes forming a heat deflection member wherein said obtuse angle is about 160°.

15. A prefabricated fireplace, comprising:
a firebox having an inner upper surface;
a baffle coupled to said inner upper surface, said baffle comprising:
a heat deflection member having a first bend along a central axis of said heat deflection member that forms first and second opposing panels; and
opposing first and second parallel edges of said heat deflection member having second and third bends formed parallel said central axis that form opposing first and second coupling flanges along at least a portion of a length of said opposing edges.

16. The prefabricated fireplace as recited in claim 15 wherein said first bend is parallel said opposing first and second parallel edges.

17. The prefabricated fireplace as recited in claim 15 wherein said first and second opposing panels are trapezoidal.

18. The prefabricated fireplace as recited in claim 15 wherein said baffle has fourth and fifth bends formed parallel said central axis that form opposing first and second panel extensions extending from said first and second coupling flanges to said first and second opposing panels, respectively.

19. The prefabricated fireplace as recited in claim 15 wherein said first bend comprises an obtuse angle.

20. The prefabricated fireplace as recited in claim 19 wherein said obtuse angle ranges from about 91° to about 179°.

21. The prefabricated fireplace as recited in claim 19 wherein said obtuse angle is about 160°.
